(19) United States
(12) Patent Application Publication
(10) Pub. No.: US 2002/0038452 A1
(43) Pub. Date: Mar. 28, 2002

(54) Constant bit folding and propagation

(75) Inventor: Alexander I. Kasinsky, Moscow (RU)

Correspondence Address: TOWNSEND AND TOWNSEND AND CREW, TWO EMBARCADERO CENTER, EIGHTH FLOOR, SAN FRANCISCO, CA, 94111-3834, US

(73) Assignee: Elbrus International, Moscow (RU)

(21) Appl. No.: 09/967,369

(22) Filed: Sep. 27, 2001

Related U.S. Application Data
(63) Continuation-in-part of application No. 09/506,408, filed on Feb. 17, 2000.

(51) Int. Cl. G06F 9/45

(52) U.S. Cl. 717/141

(57) ABSTRACT

A technique for constant bit folding, implemented by a compiler, logically processes only operand bits to generate bit sets useful for simplifying expressions. Bit sets indicating constant bits and constant bit values of the operands are generated and then logically processed to generate bit sets indicating constant bits and constant bit values of the results. Additionally, a bit set indicating operand bits that do not influence the result are generated.

### CROSS-REFERENCES TO RELATED APPLICATIONS

This application claims priority from U.S. patent Application Ser. No. 09/506,408, filed Feb. 17, 2000, the disclosure of which is incorporated herein by reference in its entirety for all purposes.

### BACKGROUND OF THE INVENTION

Constant-expression evaluation, or constant folding, refers to the evaluation at compile time of expressions whose values are known to be constant. In its simplest form, constant expression evaluation involves determining that all the operands in an expression are constant-valued, performing the evaluation of the expression at compile time, and replacing the expression by its value. For an integer, it is almost always applicable—the exceptions are cases that would produce run-time exceptions if they were executed, such as divisions by zero and overflows in languages whose semantics require overflow detection. A constant propagation method will propagate constant values throughout a program code, stimulate other constant foldings and other algebraic and peephole simplifications.

Generally, the following steps performed by a compiler to implement constant folding and expression simplification will include parsing the code to identify expressions. Then, the identified expressions are processed to evaluate constants and simplify the expressions. Finally, the simplified expressions are evaluated at run-time.

For the most part, constant folding is a complex technique and research continues to develop more efficient techniques.

### SUMMARY OF THE INVENTION

According to one aspect of the invention, a method of analysis useful for delicate constant folding and for delicate transformation of arithmetic expressions considers the result of any expression as a set of independent bits at compile time. The method is used in optimizing compilers for computer platforms with supplementary coding.

According to another aspect of the invention, four sets can be determined by processing only the operands for any expression having integer operands and an integer result:

1. The first set is a set of bits indicating which bits in the result are known to be constant, denoted the result-constant bit set (M).

2. The second set is a set of values for the constant bits in the result, denoted the result-value bit set (C). This set indicates the values, i.e., 0 or 1, of the constant values in the result-constant bit set.

3. The third set is a set of non-influence bits for each operand, indicating which bits of the operand do not influence the value of the result. This set is denoted the operand non-influence set (Nₓ for operand x).

4. The fourth set is the intersection of the non-influence bit sets of each operand indicating the bit positions in the operands that have no influence on the result and thus are not required to be processed. This set is denoted the non-influence intersection set (N).

According to another aspect of the invention, the bit sets are stored in computer memory for further processing to evaluate and simplify expressions.

According to another aspect of the invention, a result-constant bit set is obtained by performing logical operations on operand-constant bit sets and operand-value bit sets, and a result-value bit set is obtained by performing logical operations on operand-constant bit sets, operand-value bit sets, and a result-constant bit set.

According to another aspect of the invention, the method calculates values of any format, for example (8, 16, 32, 64, . . . bits). The expressions of this method may also include non-algebraic operations with structure result.

According to another aspect of the invention, the method propagates the four sets corresponding to an expression throughout the program in which the expression occurs. This method thus enables use of the four sets to evaluate the equivalence of further constant folding transformations.

According to another aspect of the invention, on a computer platform with supplementary coding detailed formulas are provided for constant folding, for logic operations {˜, |, &, ˆ }, arithmetic operations {+, −, *}, shift operations, some floating operations, and for analogs to those operations with cc flags.

According to another aspect of the invention, formulas are also provided for various combinations of those operations, which include also a set of simplifications. For example, formulas can be provided for {+, −, *, <<, >>, >>>} operations using only result-constant bit sets and result-value bit sets.

Other advantages and features of the invention will be apparent in view of the following detailed description and appended drawings.

### BRIEF DESCRIPTION OF THE DRAWINGS

FIG. 1 is a flow chart depicting the steps of a preferred embodiment for generating and storing bit sets used for constant folding.

FIG. 2 is a schematic diagram depicting the values of x, y, Mₓ, M_{y}, Cₓ, C_{y}, M and C for an or operation.

FIG. 3 is a schematic diagram depicting the values of x, y, Mₓ, M_{y}, Cₓ, C_{y}, M and C for an and operation.

FIG. 4 is a schematic diagram depicting the values of x, y, Mₓ, M_{y}, Cₓ, C_{y}, M and C for an xor operation.

FIG. 5 is a schematic diagram depicting the values of x, y, Mₓ, M_{y}, Cₓ, C_{y}, M and C for an addition operation.

FIG. 6 is a schematic diagram depicting the values of x, y, Mₓ, M_{y}, Cₓ, C_{y}, M and C for a subtraction operation.

FIG. 7 is a schematic diagram depicting the values of x, y, Mₓ, M_{y}, Cₓ, C_{y}, M and C for a shift left logic operation.

### DESCRIPTION OF THE SPECIFIC EMBODIMENTS

The invention will now be described with reference to the specific embodiments. Generally, the invention relates to methods for simplifying expressions at compiler time to reduce the number and complexity of CPU operations required to evaluate the expressions at run time.

To illustrate the value of the simplifications, consider a function ƒ(x, y, . . . , z) that has an integer result and integer arguments (operands). Each argument is considered as a set of bits. For example, in the case of a 4-bit integer representation (e.g., the constant 2 has a bit set equal to {0,0,1,0}) an argument x has a bit set {x3, x2, x1, x0}, where x3, . . . , x0 are unknown and each may have the value 0 or 1. A result bit set can be calculated for this function ƒ, and this result bit set may have a variable or a constant located at each bit position, depending on whether the values of individual bits of the operands are variable or constant. For example, the function ƒ(x)=x|2 has the binary or operation applied to the bit sets of its arguments {x3, x2, x1, x0}|{0,0,1, 0}, resulting in the bit set {x3 ,x2, 1 x0}. If all bits of a result set are constants, then the function is equivalent to this constant, for example x*0 is equivalent to 0.

If a complex function consists of small subfunctions, then the result bit set is propagated by means of an induction method. For example, consider the function ƒ(x)=((x|3)*11) & 3. The result bit set for a four-bit representation is calculated as follows:

$$( ( \{ x3 , x2 , x1 , x0 \} \vert \{ 0 , 0 , 1 , 1 \} ) * \{ 1 , 0 , 1 , 1 \} ) \& \{ 0 , 0 , 1 , 1 \} = ( \{ x3 , x2 , 1 , 1 \} * \{ 1 , 0 , 1 , 1 \} ) \& \{ 0 , 0 , 1 , 1 \} = \{ x3 + x2 , x2 , 0 , 1 \} \& \{ 0 , 0 , 1 , 1 \} = \{ 0 , 0 , 0 , 1 \}$$

So function ƒ(x) is equivalent to constant 1.

Similarly, if ƒ(x)=((x|13)*11) & 6, then the result bit set is:

$$( ( \{ x3 , x2 , x1 , x0 \} \vert \{ 0 , 0 , 1 , 1 \} ) * \{ 1 , 0 , 1 , 1 \} ) \& \{ 0 , 0 , 1 , 1 \} = ( \{ x3 , x2 , 1 , 1 \} * \{ 1 , 0 , 1 , 1 \} ) \& \{ 0 , 0 , 1 , 1 \} = \{ x3 + x2 , x2 , 0 , 1 \} \& \{ 0 , 1 , 1 , 0 \} = \{ 0 , x2 , 0 , 0 \} = \{ x3 , x2 , x1 , 0 \} \& \{ 0 , 1 , 0 , 0 \}$$

Thus,ƒ(x)=x & 4. At runtime, calculating x & 4 will produce the same result as calculating ((x|3)*11) & 6, but with fewer operations.

To enable a compiler to identify such simplifications, an embodiment of the present invention calculates bit sets on which operations can be performed to determine appropriate simplifications. For each operand, two bit sets are defined. One is an operand-constant bit set (denoted Mₓ, for operand x) that is defined such that the value of a bit in Mₓ indicates whether the corresponding bit in operand x has a constant (known) or non-constant (variable) value at compile time. In a preferred embodiment, a given bit in Mₓ has value 1 if the corresponding bit in operand x has a constant value, value 0 otherwise. The other is an operand-value bit set (denoted Cₓ for operand x), defined such that the value of a bit in Cₓ indicates the value of a corresponding bit in operand x, if that bit in operand x is constant at compile time. In a preferred embodiment, a given bit in Cₓ has value 1 if the corresponding bit in operand x has constant value 1; the bit has value 0 if the corresponding bit in operand x has constant value 0 or non-constant value.

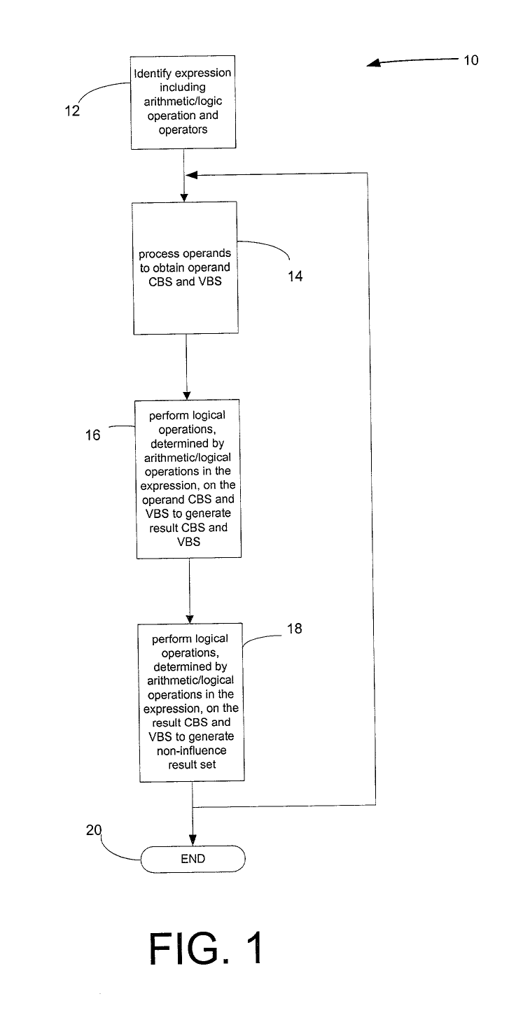

FIG. 1 depicts the steps implemented by an embodiment of the invention: first the M and C bit sets are calculated for the operands; second, the M and C bit sets of the operands are utilized to calculate the M and C bit sets of the results; third, the result M and C bit sets are utilized to calculate the non-influence bit sets; and, finally, the non-influence bit sets are stored for use in simplifying expressions at compile time.

In a preferred embodiment the following four sets are calculated from the operand bit sets:

1. A set of bits indicating which bits in the result of an operation are known to be constant, called the result-constant bit set (M). In an example embodiment, a bit in set M has value 1 when the corresponding bit in the result is constant, 0 when the corresponding bit is not constant.

2. A set of values for the constant bits in the result, called the result-value bit set (C). This set indicates the values, i.e., 0 or 1, of the constant bits in the result-constant bit set. In an example embodiment, when a bit in the result is not constant the corresponding bit in C has value 0.

3. A set of non-influence bits for each operand, indicating which bits of the operand do not influence the value of the result. This set is called the operand non-influence set (Nₓ for operand x). In an example embodiment, a bit in this set has value 0 when the corresponding bit in the operand does not influence the result of the operation, 1 when the corresponding bit can influence the result.

4. The intersection of the non-influence bit sets of each operand indicating the bit positions in the operands that have no influence on the result and thus are not required to be processed. This set is called the non-influence intersection set (N).

These sets can be used by a compiler to determine simplified expressions that are equivalent to the initial expressions. Substitution of the simplified expression in the executable code reduces the CPU load at runtime, resulting in more efficient program execution.

### Specific Algorithms

For each operation, an algorithm is provided to the compiler to calculate the sets M and C, as well as Nₓ and N in cases where these last two sets are useful. By way of illustration, specific algorithms for determining sets M, C, Nₓ, and N are provided below for the following operations:

| | |
|---|---|
| ˜ | binary negation (not) |
| \| | binary or (or) |
| & | binary and (and) |
| ˆ | binary nonequivalence (xor) |
| + | integer addition (add) |
| − | integer subtraction (sub) |
| * | integer multiply (mul) |
| << | shift left logic (sll) |
| >> | shift right logic (srl) |
| >>> | shift right arithmetic (sra) |

A general overview of the operation of this embodiment is currently depicted in the flow chart 10 of FIG. 1. First, in step 12, the compiler will utilize standard techniques to identify expressions in the code. Following step 12, step 14 processes the operands to obtain the constant bit set (CBS) and value bit set (VBS) for each operand. As described in detail below, these bit sets are obtained by performing logical operations on the operand bit sets. Which operations are performed depends on the operations included in the expression. The operand bit sets are processed to obtain the result CBS and VBS in step 16. Thus, the result bit sets are obtained solely from processing the known operand bits sets based on the operations included in the expression.

Finally, in step 18, the result bit sets may be processed to obtain a non-influence bit set identifying bits in the operands that do not influence the value of the result, ending with step 20. Alternatively, a decision may be made to return to step 14 to repeat operand processing. As illustrated below, the non-influence bit set may be utilized to simplify expressions at the compiler level so that the number of cycles scheduled for run-time to execute the expression can be reduced.

1. Algorithm for not Operation.

The following algorithm can be used to calculate the result-constant bit set M and the result-value bit set C from bit sets Mₓ, Cₓ for the not operation (˜x):

M=Mₓ;

C=˜Cₓ & M.

These equations signify that a bit in ˜x is constant when the corresponding bit in x is constant. The known bits in ˜x will have opposite values from the corresponding bits in x, and the bits in C have value 1 only if the corresponding bit in x is known.

For example, consider the case where x={1, x2, x1, 0}. Then the operand known-bit set Mₓ is {1,0,0,1} and the operand-value bit set Cₓ is {1,0,0,0}, indicating that the highest bit of x has constant value 1, the lowest bit of x has constant value 0, and the middle two bits have variable values. Applying the above algorithm to the example operand yields:

M={1,0,0,1};

C=˜{1,0,0,0}&{1,0,0,1}={0,1,1,1}& {1,0,0,1}={0,0,0,1}.

The presence of bit value 1 in the high and low positions of set M indicates that the values of the corresponding bits of ˜x are known. From the values in corresponding positions of set C, it follows that the highest bit in ˜x has value 0 and the lowest bit has value 1.

The non-influence set for this operation is not of much interest; clearly every bit in x influences the result of ˜x.

2. Algorithm for OR Operation.

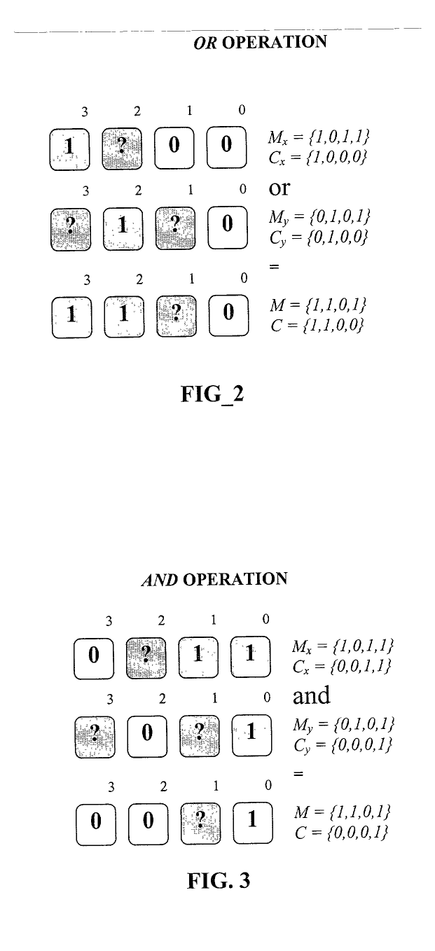

FIG. 2 is a diagrammatic illustration of bit sets Mₓ, M_{y}, Cₓ, C_{y} calculated from similar bit sets M and C using the OR operation x|y:

C=Cₓ|C_{y};

M=Mₓ&M_{y}|C.

Nₓ=C_{y}|N;

N_{y}=Cₓ|N

For example, take x|y in which x={1, x2, x1, 0} and y={y3, 1, y1, 0}. Then, employing the relationships set forth above, as illustrated in FIG. 2,

Mₓ={1,0,1,1}, Cₓ={1,0,0,0,}(row 22, FIG. 2) and

M_{y}={0,1,0,1}, C_{y}={0,1,0,0,}(row 24).

The result, as shown in row 26, will be

$$C = \{ 1 , 0 , 0 , 0 \} \vert \{ 0 , 1 , 0 , 0 \} = \{ 1 , 1 , 0 , 0 \} , and$$

$$\begin{matrix}M = \{ 1 , 0 , 1 , 1 \} \& \{ 0 , 1 , 0 , 1 \} \vert \{ 1 , 1 , 0 , 0 \} \\ = \{ 0 , 0 , 0 , 1 \} \vert \{ 1 , 1 , 0 , 0 \} \\ = \{ 1 , 1 , 0 , 1 \} .\end{matrix}$$

Note that the ones in Mₓ and M_{y} correspond to the location of know bit in the associated variable.

Thus, for this example, the values of all bits in (x|y) except the second lowest bit are known, as indicated by the 1's in set M. The two highest bits each have constant value 1 as indicated by the 1's in set C, and the lowest bit has constant value 0, as indicated by the 0 in that position in set C.

The non-influence sets for the two operands in the or operation are calculated with the following algorithm:

Nₓ=C_{y}|N,

and

N_{y}=Cₓ|N.

That is, a bit in operand x(y) does not affect the result if the corresponding bit in operand y(x) is fixed and its value is 1; in any other case, the bit in operand x(y) does affect the result.

In the example where x={1, x2, x1, 0}, and y={y3, 1, y1, 0}, and N={0,0,0,0}, the algorithm yields:

Nₓ={0,1,0,0}|{0,0,0,0}={0,1,0,0};

N_{y}={1,0,0,0}|{0,0,0,0}={1,0,0,0},

The value 1 in the second bit of Nₓ indicates that the (unknown) value of x2 is irrelevant to the result; the value 0 in the third bit indicates that the value of x1 is relevant. Similarly, the value 1 in the highest bit of N_{y} indicates that the value of y3 is irrelevant to the result, and the value 0 in the third bit indicates the value of y1 is relevant.

3. Algorithm for and Operation.

FIG. 3 diagrammatically illustrates the calculation of bit sets M, C from similar bit sets Mₓ, M_{y}, Cₓ, C_{y} for the and operation x & y:

M=Mₓ&M_{y}|Mₓ&˜Cₓ|M_{y}&˜C_{y};

C=Cₓ&C_{y}.

Nₓ=C_{y}|N;

N_{y}=Cₓ|N_{z}

Note that the 1's in Mₓ and M_{y} correspond to the location of the known bit in the associated variable. FIG. 3 illustrates x & y with Mₓ={1,0,1,1}, Cₓ={0,0,1,1} and M_{y}={0,1,0,1}, C_{y}={0,0,0,1} to achieve:

$$\begin{matrix}M = \{ 1 , 0 , 1 , 1 \} \& \{ 0 , 1 , 0 , 1 \} \vert \{ 1 , 0 , 1 , 1 \} \& \sim \{ 0 , 0 , 1 , 1 \} \vert \{ 0 , 1 , 0 , 1 \} \& \\ \sim \{ 0 , 0 , 0 , 1 \} \\ = \{ 0 , 0 , 0 , 1 \} \vert \{ 1 , 0 , 0 , 1 \} \& \{ 1 , 1 , 0 , 0 \} \vert \{ 0 , 1 , 0 , 1 \} \& \{ 1 , 1 , 1 , 0 \} \\ = \{ 0 , 0 , 0 , 1 \} \vert \{ 1 , 0 , 0 , 0 \vert \{ 0 , 1 , 0 , 0 \} \\ = \{ 1 , 0 , 0 , 1 \} \vert \{ 0 , 1 , 0 , 0 \} \\ = \{ 1 , 1 , 0 , 1 \} ;\end{matrix}$$

$$C = \{ 0 , 0 , 1 , 1 \} \& \{ 0 , 0 , 0 , 1 \} = \{ 0 , 0 , 0 , 1 \} .$$

As a farther example, consider the case where x={1, x2, x1, 0} and y={y3, 1, y1, 0}, and N={0,0,0,0}. As before, Mₓ={1,0,0,1}, Cₓ={1,0,0,0} and M_{y}={0,1,0,1}, C_{y}={0,1,0,0}. The and algorithm yields:

$$\begin{matrix}M = \{ 1 , 0 , 0 , 1 \} \& \{ 0 , 1 , 0 , 1 \} \vert \{ 1 , 0 , 0 , 1 \} \& \sim \{ 1 , 0 , 0 , 1 \} \vert \{ 0 , 1 , 0 , 1 \} \& \\ \sim \{ 0 , 1 , 0 , 0 \} \\ = \{ 0 , 0 , 0 , 1 \} \vert \{ 1 , 0 , 0 , 1 \} \& \{ 0 , 1 , 1 , 1 \} \& \{ 1 , 0 , 1 , 1 \} \\ = \{ 0 , 0 , 0 , 1 \} \vert \{ 0 , 0 , 0 , 1 \} \vert \{ 0 , 0 , 0 , 1 \} \\ = \{ 0 , 0 , 0 , 1 \} \vert \{ 0 , 0 , 0 , 1 \} \\ = \{ 0 , 0 , 0 , 1 \} ;\end{matrix}$$

$$C = \{ 1 , 0 , 0 , 0 \} \& \{ 0 , 1 , 0 , 0 \} = \{ 0 , 0 , 0 , 0 \} ;$$

So the lowest bit of x & y is known and equals 0. Other bits of x & y are not known.

For x & y, the non-influence sets are calculated via the following algorithm:

Nₓ=M_{y}&˜C_{y}|N;

N_{y}=Mₓ&˜Cₓ|N.

That is, a bit in operand x(y) is irrelevant only when the corresponding bit in operand y(x) has constant value 0. Thus, for the example operands above:

Nₓ={0,1,0,1}&˜{0,1,0,0}|{0,0,0,0}={0,1,0,1}&{1,0,1,1}={0,0,0,1};

N_{y}={1,0,0,1}&˜{1,0,0,0}|{0,0,0,0}={1,0,0,1}&{0,1,1,1}={0,0,0,1}.

4. Algorithm for xor Operation

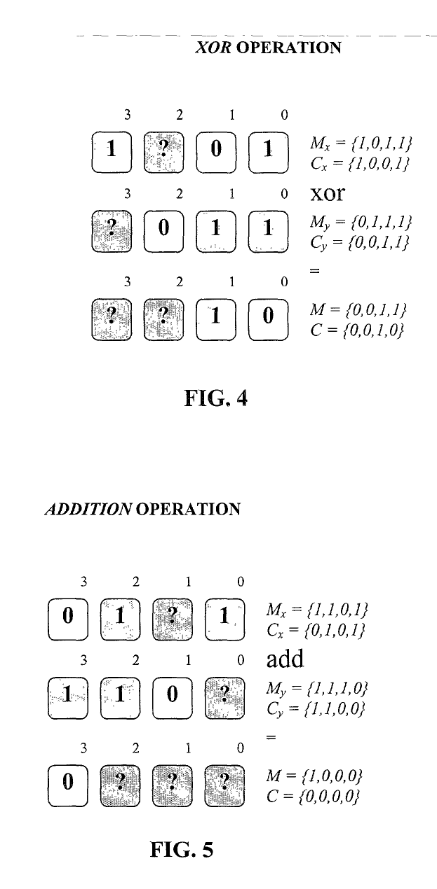

FIG. 4 is a diagrammatic illustration of the relationship of x, y, Mₓ, M_{y}, Cₓ, C_{y}, M and C an xor (xˆ y) operation. Note that the ones in Mₓ and M_{y} correspond to the location of know bit in the associated variable. The technique for calculating M and C from Mₓ, M_{y}, Cₓ, and C_{y} will now be described. FIG. 4 illustrates the calculation of M, C from bit sets Mₓ={1,0,1,1}, Cₓ={1,0,0,1} and M_{y}={0,1,1,1}, C_{y}={0,0,1,1} for an exclusive or operation (xˆ y):

M=Mₓ&M_{y};

C=(Cₓˆ C_{y})&M;

Nₓ=N;

N_{y}=N.

As FIG. 4 illustrates for the bit sets and relationships presented above, the results will be

$$M = \{ 1 , 0 , 1 , 1 \} \& \{ 0 , 1 , 1 , 1 \} = \{ 0 , 0 , 1 , 1 \}$$

$$\begin{matrix}C = ( \{ 1 , 0 , 0 , 1 \} ⋀ \{ 0 , 0 , 1 , 1 \} ) \& \{ 0 , 0 , 1 , 1 \} = \{ 1 , 0 , 1 , 0 \} \& \{ 0 , 0 , 1 , 1 ) \\ = \{ 0 , 0 , 1 , 0 \} ;\end{matrix}$$

$${N}_{x} = N = \{ 0 , 0 , 0 , 0 \} ;$$

$${N}_{y} = N = \{ 0 , 0 , 0 , 0 \} .$$

As another example, consider the case of x={1, x2 x1, 0} and y={y3, 1, y1, 0}. As before, Mₓ={1,0,0,1}, Cₓ={1,0,0,0} and M_{y}={0,1,0,1}, C_{y}={0,1,0,0}. The above algorithm for xor yields:

M={1,0,0,1}&{0,1,0,1}={0,0,0,1};

C=({1,0,0,0}ˆ {0,1,0,0})&{0,0,0,1}={1,1,0,0}&{0,0,0,1}={0,0,0,0};

That is, the lowest bit of xˆ y has constant value 0. The other bits are not known.

For xˆ y, the operand non-influence sets are:

Nₓ=N={0,0,0,0};

N_{y}=N={0,0,0,0}.

This signifies that each bit in both operands is always relevant in operation xor.

5. Algorithm for ADDITION Operation

FIG. 5 is a schematic diagram depicting the relationship of x, y, Mₓ, M_{y}, Cₓ, C_{y}, M and C for a concrete example of an ADDITION operation. Note that the ones in Mₓ and M_{y} correspond to the location of know bit in the associated variable. The technique for calculating M and C from Mₓ, M_{y}, Cₓ, and C_{y} will now be described.

The following algorithm can be used to calculate bit sets M, C from bit sets Mₓ, Cₓ, M_{y}, C_{y} for operation x+y:

First, calculate a preliminary set C=Cₓ+C_{y}.

Then use this preliminary set C to calculate M according to the following equation:

M=Mₓ&M_{y}&(Cˆ ˜((Cₓ|˜Mₓ)+(C_{y}|˜M_{y})))&(Cˆ ˜(Cₓ+(C_{y}|˜M_{y})))&(Cˆ ˜((Cₓ|˜Mₓ)+C_{y})).

Finally, use the values of M and the preliminary set C to calculate the final result-value bit set:

C=C&M;

The last step enforces the convention that a bit in C is 0 when the bit in the result is not known.

FIG. 5 illustrates the x+y operation for the bit sets Mₓ={1,1,0,1}, Cₓ={0,1,0,1} and M_{y}={1,1,1,0}, C_{y}={1,1,1,0}. C, M, C, Nₓ, and N_{y}, using the above-identified relationships, first obtain C

C={0,1,0,1}+{1,1,0,0}={0,0,0,1};

Then, using C, determine M

$$M = \{ 1 , 1 , 0 , 1 \} \& \{ 1 , 1 , 1 , 0 \} \& ( \{ 0 , 0 , 0 , 1 \} \hat{} \sim ( ( \{ 0 , 1 , 0 , 1 \} \vert \sim \{ 1 , 1 , 0 , 1 \} + ( \{ 1 , 1 , 0 , 0 \} \vert \sim \{ 1 , 1 , 1 , 0 \} ) ) ) \& ( \{ 0 , 0 , 0 , 1 \} \hat{} \sim ( \{ 0 , 1 , 0 , 1 \} + ( \{ 1 , 1 , 0 , 0 \} \vert \sim \{ 1 , 1 , 1 , 0 \} ) ) ) \& ( \{ 0 , 0 , 0 , 1 \} \hat{} \sim ( ( \{ 0 , 1 , 0 , 1 \} \vert \sim \{ 1 , 1 , 0 , 1 \} ) + \{ 1 , 1 , 0 , 0 \} ) ) ) = \{ 1 , 1 , 0 , 0 \} \& ( \{ 0 , 0 , 0 , 1 \} \hat{} \sim ( ( \{ 0 , 1 , 0 , 1 \} \vert \{ 0 , 0 , 1 , 0 \} ) + ( \{ 1 , 1 , 0 , 0 \} \vert \{ 0 , 0 , 0 , 1 \} ) ) ) \& ( \{ 0 , 0 , 0 , 1 \} \hat{} \sim ( \{ 0 , 1 , 0 , 1 \} + ( \{ 1 , 1 , 0 , 0 \} \vert \{ 0 , 0 , 0 , 1 \} ) ) ) \& ( \{ 0 , 0 , 0 , 1 \} \hat{} \sim ( ( \{ 0 , 1 , 0 , 1 \} \vert \{ 0 , 0 , 1 , 0 ) \} + \{ 1 , 1 , 0 , 0 \} ) ) = \{ 1 , 1 , 0 , 0 \} \& ( \{ 0 , 0 , 0 , 1 \} \hat{} \sim ( \{ 0 , 1 , 1 , 1 \} + \{ 1 , 1 , 0 , 1 \} ) ) \& ( \{ 0 , 0 , 0 , 1 \} \hat{} \sim ( \{ 0 , 1 , 0 , 1 \} + \{ 1 , 1 , 0 , 1 \} ) ) \& ( \{ 0 , 0 , 0 , 1 \} \hat{} \sim ( \{ 0 , 1 , 1 , 1 \} + \{ 1 , 1 , 0 , 0 , \} ) ) = \{ 1 , 1 , 0 , 0 \} \& ( \{ 0 , 0 , 0 , 1 \} \hat{} \sim \{ 0 , 1 , 0 , 0 \} ) \& ( \{ 0 , 0 , 0 , 1 \} \hat{} \sim \{ 0 , 0 , 1 , 0 \} ) \& ( \{ 0 , 0 , 0 , 1 \} \hat{} \sim \{ 0 , 0 , 1 , 1 \} ) = \{ 1 , 1 , 0 , 0 \} \& ( \{ 0 , 0 , 0 , 1 \} \hat{} \{ 1 , 0 , 1 , 1 \} ) \& ( \{ 0 , 0 , 0 , 1 \} \hat{} \{ 1 , 1 , 0 , 1 \} ) \& ( \{ 0 , 0 , 0 , 1 \} \hat{} \{ 1 , 1 , 0 , 0 \} ) = \{ 1 , 1 , 0 , 0 \} \& \{ 1 , 0 , 1 , 0 \} \& \{ 1 , 1 , 0 , 0 \} \& \{ 1 , 1 , 0 , 1 \} = \{ 1 , 0 , 0 , 0 \} \& \{ 1 , 1 , 0 , 0 \} = \{ 1 , 0 , 0 , 0 \} ;$$

$$C = \{ 0 , 0 , 0 , 1 \} \& \{ 1 , 0 , 0 , 0 \} = \{ 0 , 0 , 0 , \} ;$$

$${N}_{x} = 0 = \{ 0 , 0 , 0 , 0 \} ;$$

$${N}_{y} = 0 = \{ 0 , 0 , 0 , 0 \} .$$

As another illustration of the ADDITION operation, consider the case of x={1, x2, x1, 0} and y={y3, 1, y1, 0}. Then Mₓ={1,0,0,1}, Cₓ={1,0,0,0} and M_{y}={0,1,0,1}, C_{y}={0,1,0,0}. Then the algorithm yields:

Preliminary C={1,0,0,0}+{0,1,0,0}={1,1,0,0};

$$\begin{matrix}M = \{ 1 , 0 , 0 , 1 \} \& \{ 0 , 1 , 0 , 1 \} \& \\ ( \{ 1 , 1 , 0 , 0 \} \hat{} \sim ( ( 1 , 0 , 0 , 0 \} \vert \sim \{ 1 , 0 , 0 , 1 \} ) + \\ ( \{ 0 , 1 , 0 , 0 \} \vert \sim \{ 0 , 1 , 0 , 1 \} ) ) ) \& ( 1 , 1 , 0 , 0 \} \hat{} \sim \\ ( ( \{ 1 , 0 , 0 , 0 \} ) + ( \{ 0 , 1 , 0 , 0 \} \vert \sim \{ 0 , 1 , 0 , 1 \} ) ) ) \& \\ ( \{ 1 , 1 , 0 , 0 \} \hat{} \sim ( ( \{ 1 , 0 , 0 , 0 \} \vert \sim \{ 1 , 0 , 0 , 1 \} ) + ( 0 , 1 , 0 , 0 \} ) ) ) \\ = ( \{ 1 , 1 , 0 , 0 \} \hat{} \sim ( ( \{ 1 , 0 , 0 , 0 \} \vert \{ 0 , 1 , 1 , 0 \} ) + \\ ( \{ 0 , 1 , 0 , 0 \} \vert \{ 1 , 0 , 1 , 0 \} ) ) ) \& ( \{ 1 , 1 , 0 , 0 \} \hat{} \sim \\ ( ( \{ 1 , 0 , 0 , 0 \} ) + ( \{ 0 , 1 , 0 , 0 \} \vert \{ 1 , 0 , 1 , 0 \} ) ) ) \& \\ ( \{ 1 , 1 , 0 , 0 ) \hat{} \sim ( ( \{ 1 , 0 , 0 , 0 \} \vert \{ 0 , 1 , 1 , 0 \} + ( \{ 0 , 1 , 0 , 0 \} ) ) ) \\ = ( \{ 1 , 1 , 0 , 0 \} \hat{} \sim ( \{ 1 , 1 , 1 , 0 \} + \{ 1 , 1 , 1 , 0 \} ) ) ) \& \\ ( \{ 1 , 1 , 0 , 0 \} \hat{} \sim ( \{ 1 , 1 , 1 , 0 \} + \{ 0 , 1 , 0 , 0 \} ) ) \\ = ( \{ 1 , 1 , 0 , 0 \} \hat{} \sim \{ 1 , 1 , 0 , 0 \} ) \& ( \{ 1 , 1 , 0 , 0 \} \hat{} \sim \{ 0 , 0 , 1 , 0 \} ) \\ = ( \{ 1 , 1 , 0 , 0 \} \hat{} \{ 0 , 0 , 1 , 1 \} ) \& ( \{ 1 , 1 , 0 , 0 \} \hat{} \{ 1 , 0 , 0 , 1 \} \& \\ ( \{ 1 , 1 , 0 , 0 \} \hat{} \{ 1 , 1 , 0 , 1 \} ) \\ = \{ 1 , 1 , 1 , 1 \} \& \{ 0 , 1 , 0 , 1 \} \& \{ 0 , 0 , 0 , 1 \} = \{ 0 , 1 , 0 , 1 \} + \\ \{ 0 , 0 , 01 \}\end{matrix}$$

Thus: M={0,0,0,1};

C={1,1,0,0}& {0,0,0,1}={1,1,0,0}

The low-order bit of x +y is known and equal to 0. Other bits are not known.

For x+y, the operand non-influence sets are:

Nₓ=0={0,0,0,0};

N_{y}=0={0,0,0,0}.

This signifies that each bit in both operands is always relevant in operation add.

6. Algorithm for SUBTRACTION Operation

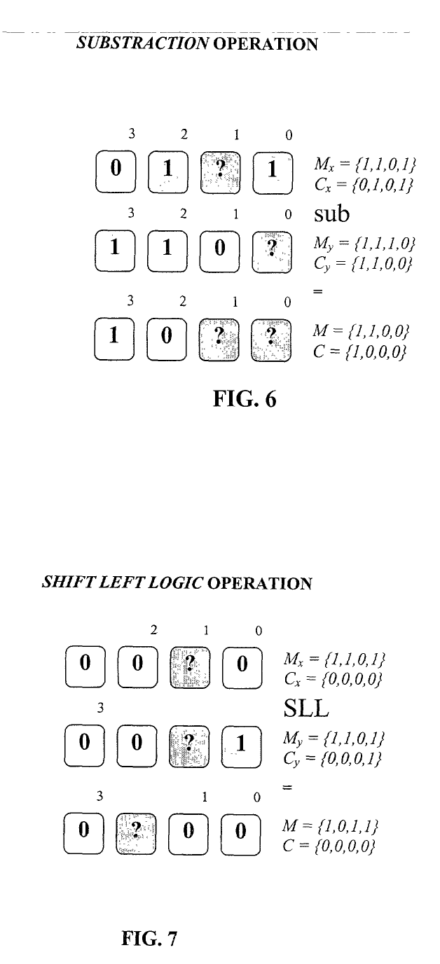

FIG. 6 is a schematic diagram depicting the relationship of x, y, Mₓ, M_{y}, Cₓ, C_{y}, M and C for a concrete example of an SUBTRACTION operation. Note that the ones in Mₓ and M_{y} correspond to the location of know bit in the associated variable. The technique for calculating M and C from Mₓ, M_{y}, Cₓ, and C_{y} will now be described.

The following algorithm can be used to calculate bit sets M, C from bit sets Mₓ, Cₓ, M_{y}, C_{y} for operation x−y:

C=Cₓ−C_{y};

M=Mₓ&M_{y}&(Cˆ ˜((Cₓ|˜Mₓ)−(C_{y}|˜M_{y})))&(Cˆ ˜(Cₓ−(C_{y}|˜M_{y})))&(Cˆ ˜((Cₓ|˜Mₓ)−C_{y}));

C=C&M.

FIG. 6 illustrates calculating bits sets M and C from similar bit sets Mₓ, Cₓ, M_{y}, and C_{y} for the SUBTRACTION operation, x−y, using the relationships set forth above. Thus,

$$C = \{ 0 , 1 , 0 , 1 \} - \{ 1 , 1 , 0 , 0 \} = \{ 1 , 0 , 0 , 1 \} ;$$

$$M = \{ 1 , 1 , 0 , 1 \} \& \{ 1 , 1 , 1 , 0 \} \& ( \{ 1 , 0 , 0 , 1 \} \hat{} \sim ( ( \{ 0 , 1 , 0 , 1 \} \vert \sim \{ 1 , 1 , 0 , 1 \} ) - ( \{ 1 , 1 , 0 , 0 \} \vert \sim \{ 1 , 1 , 1 , 0 \} ) ) ) \& ( \{ 1 , 0 , 0 , 1 \} \hat{} \sim ( \{ 0 , 1 , 0 , 1 \} - ( \{ 1 , 1 , 0 , 0 \} \vert \sim \{ 1 , 1 , 1 , 0 \} ) ) ) \& ( \{ 1 , 0 , 0 , 1 \} \hat{} \sim ( ( \{ 0 , 1 , 0 , 1 \} \vert \sim \{ 1 , 1 , 0 , 1 \} ) - \{ 1 , 1 , 0 , 0 \} ) ) = \{ 1 , 1 , 0 , 0 \}$$

Again consider the case where x={1, x2, x1, 0} and y={y3, 1, y1, 0}. Then Mₓ={1,0,0,1}, Cₓ={1,0,0,0} and M_{y}={0,1,0,1}, C_{y}={0,1,0,0}. Then the algorithm yields:

$$C = \{ 1 , 0 , 0 , 0 \} - \{ 0 , 1 , 0 , 0 \} = \{ 0 , 1 , 0 , 0 \} ;$$

$$\begin{matrix}M = \{ 1 , 0 , 0 , 1 \} \& \{ 0 , 1 , 0 , 1 ) \& \\ ( \{ 1 , 1 , 0 , 0 \} \hat{} \sim ( ( \{ 1 , 0 , 0 , 0 \} \vert \sim \{ 1 , 0 , 0 , 1 \} ) - ( \{ 0 , 1 , 0 , 0 \} \vert \sim \{ 0 , 1 , 0 , 1 \} ) ) ) \& \\ ( \{ 1 , 1 , 0 , 0 \} \hat{} \sim ( ( \{ 1 , 0 , 0 , 0 \} ) - ( \{ 0 , 1 , 0 , 0 \} \vert \sim \{ 0 , 1 , 0 , 1 \} ) ) ) \& \\ ( \{ 1 , 1 , 0 , 0 \} \hat{} \sim ( ( \{ 1 , 0 , 0 , 0 \} \vert \sim \{ 1 , 0 , 0 , 1 \} ) - ( \{ 0 , 1 , 0 , 0 \} ) ) ) \\ = ( \{ 1 , 1 , 0 , 0 \} \hat{} \sim ( ( \{ 1 , 0 , 0 , 0 \} \vert \{ 0 , 1 , 1 , 0 \} ) - ( \{ 0 , 1 , 0 , 0 \} \vert \{ 1 , 0 , 1 , 0 \} ) ) ) \& \\ ( \{ 1 , 1 , 0 , 0 \} \hat{} \sim ( ( \{ 1 , 0 , 0 , 0 \} ) - ( \{ 0 , 1 , 0 , 0 \} \vert \{ 1 , 0 , 1 , 0 \} ) ) ) \& \\ ( \{ 1 , 1 , 0 , 0 \} \hat{} \sim ( ( \{ 1 , 0 , 0 , 0 \} \vert \{ 0 , 1 , 1 , 0 \} ) - ( \{ 0 , 1 , 0 , 0 \} ) ) ) \\ = ( \{ 1 , 1 , 0 , 0 \} \hat{} \sim ( \{ 1 , 1 , 1 , 0 \} - \{ 1 , 1 , 1 , 0 \} ) ) \& \\ ( \{ 1 , 1 , 0 , 0 \} \hat{} \sim ( \{ 1 , 0 , 0 , 0 \} - \{ 1 , 1 , 1 , 0 \} ) ) \& \\ ( \{ 1 , 1 , 0 , 0 \} \hat{} \sim ( \{ 1 , 1 , 1 , 0 \} - \{ 0 , 1 , 0 , 0 \} ) ) \\ = ( \{ 1 , 1 , 0 , 0 \} \hat{} \sim \{ 0 , 0 , 0 , 0 \} ) \& ( \{ 1 , 1 , 0 , 0 \} \hat{} \sim \{ 1 , 0 , 1 , 0 \} ) \& \\ \{ 1 , 1 , 0 , 0 \} \hat{} \sim \{ 1 , 0 , 1 , 0 \} ) \\ = ( \{ 1 , 1 , 0 , 0 \} \hat{} \{ 1 , 1 , 1 , 1 \} ) \& ( \{ 1 , 1 , 0 , 0 \} \hat{} \{ 0 , 1 , 0 , 1 \} ) \& \\ ( \{ 1 , 1 , 0 , 0 \} \hat{} \{ 0 , 1 , 0 , 1 \} ) \\ = \{ 0 , 0 , 1 , 1 \} \& \{ 1 , 0 , 0 , 1 \} \& \{ 1 , 0 , 0 , 1 \} \\ = \{ 0 , 0 , 0 , 1 \} \& \{ 1 , 0 , 0 , 1 \}\end{matrix}$$

Thus: M={0,0,0,1}.

C={0,1,0,0}&{0,0,0,1}={0,0,0,0};

So the low-order bit of x−y is known and equal to 0. Other bits are not known.

For x−y, the operand non-influence sets are:

Nₓ=0={0,0,0,0};

N_{y}=0={0,0,0,0}.

This signifies that each bit in both operands is always relevant in operation sub.

7. Algorithm for MULTIPLY Operation

The following algorithm can be used to calculate bit sets M, C from similar bit sets Mₓ, Cₓ, M_{y}, C_{y} for operation x*y:

Step 1:

M=−(M_{y} & 1);

C=−(C_{y} & 1);

M=Mₓ & M|Mₓ & ˜Cₓ|M_{y} & ˜C_{y};

C=C & Cₓ;

i=1;

Step 2:

If i>=size of C in bits, go to Quit;

Step 3:

Mₓ=Mₓ<<1;

Mₓ=Mₓ|1;

Cₓ=Cₓ<<1;

M_{y}=M_{y}>>1;

C_{y}=C_{y}>>1;

M_{yy}=−(M_{y} & 1);

C_{y}y=−(C_{y} & 1);

M_{yy=M}ₓ & M_{yy}|Mₓ & ˜Cₓ|M_{y} & ˜C_{yy};

C_{yy}=C_{yy} & Cₓ;

CC=C+C_{yy};

M=M & M_{yy} & (CCˆ ˜((C|˜M)+(C_{yy}|˜M_{yy}))) & (CCˆ ˜(C+(C_{yy}|˜M_{yy}))) & (CCˆ ˜((C|˜M)+C_{yy}));

C=CC & M;

i=i+1;

go to Step 2;

Quit.

Here the sets M_{yy}, C_{yy}, CC are temporary sets.

As an example, consider the case where x={1, x2, x1, 0} and y={y3, 1, y1, 0}. Then Mₓ={1,0,0,1}, Cₓ={1,0,0,0} and M_{y}={0,1,0,1}, C_{y}={0,1,0,0}. Then the algorithm proceeds as follows:

$$\text{Step 1:} \\ M = - ( {M}_{y} \& 1 ) = - ( \{ 0 , 1 , 0 , 1 \} \& \{ 0 , 0 , 0 , 1 \} ) = - \{ 0 , 0 , 0 , 1 \} = \{ 1 , 1 , 1 , 1 \} ; \\ C = - ( {C}_{y} \& 1 ) = - ( \{ 0 , 1 , 0 , 0 \} \& \{ 0 , 0 , 0 , 1 \} ) = - \{ 0 , 0 , 0 , 1 \} = \{ 0 , 0 , 0 , 0 \} ; \\ \begin{matrix}M = ( \sim {C}_{x} \vert C ) \& {M}_{x} \vert \sim C \& - ( {M}_{y} \& 1 ) \\ = ( \sim \{ 1 , 0 , 0 , 0 \} \vert \{ 1 , 1 , 1 , 1 \} ) \& \{ 1 , 0 , 0 , 1 \} \vert \sim \{ 1 , 1 , 1 , 1 ) \& - ( \{ 0 , 1 , 0 , 1 \} \& \{ 0 , 0 , 0 , 1 \} ) \\ = ( \{ 0 , 1 , 1 , 1 \} \vert \{ 1 , 1 , 1 , 1 ) ) \& \{ 1 , 0 , 0 , 1 \} \vert \{ 0 , 0 , 0 , 0 ) \& - \{ 0 , 0 , 0 , 1 \} \\ = \{ 1 , 1 , 1 , 1 \} \& \{ 1 , 0 , 0 , 1 \} \vert \{ 0 , 0 , 0 , 0 ) \& \{ 1 , 1 , 1 , 0 \} \\ = \{ 1 , 0 , 0 , 1 \} \vert \{ 0 , 0 , 0 , 0 \} = \{ 1 , 0 , 0 , 1 \} ;\end{matrix} \\ C = C \& {C}_{x} = \{ 0 , 0 , 0 , 0 \} \& \{ 1 , 0 , 0 , 0 \} = \{ 1 , 0 , 0 , 0 \} ; \\ \begin{matrix}M = {M}_{x} \& M \vert {M}_{x} \& \sim {C}_{x} \vert M \& \sim C ; \\ = \{ 1 , 0 , 0 , 1 \} \& \{ 1 , 1 , 1 , 1 \} \vert \{ 1 , 0 , 0 , 1 \} \& - \{ 1 , 0 , 0 , 0 \} \vert \{ 1 , 1 , 1 , 1 \} \& \sim \{ 0 , 0 , 0 , 0 \} \\ = \{ 1 , 0 , 0 , 1 \} \vert \{ 1 , 0 , 0 , 1 \} \& \{ 0 , 1 , 1 , 1 \} \vert \{ 1 , 1 , 1 , 1 \} \& \{ 1 , 1 , 1 , 1 \} \\ = \{ 1 , 0 , 0 , 1 \} \vert \{ 0 , 0 , 0 , 1 \} \vert \{ 1 , 1 , 1 , 1 \} = \{ 1 , 1 , 1 , 1 \}\end{matrix} \\ C = C \& {C}_{x} = \{ 0 , 0 , 0 , 0 \} \& \{ 1 , 0 , 0 , 0 \} = \{ 0 , 0 , 0 , 0 \} \\ i = 1 ; \\ \text{Step 2:} \\ If i > = 4 , go to Quit ; \# here i ⩵ 1 \\ \text{Step 3:} \\ {M}_{x} = {M}_{x} ⪡ 1 = \{ 1 , 0 , 0 , 1 \} ⪡ 1 = \{ 0 , 0 , 1 , 0 \} \\ {M}_{x} = {M}_{x} \vert 1 = \{ 0 , 0 , 0 , 1 \} \vert \{ 0 , 0 , 0 , 1 \} = \{ 0 , 0 , 1 , 1 \} ;$$

$${C}_{x} = {C}_{x} ⪡ 1 = \{ 1 , 0 , 0 , 0 \} ⪡ 1 = \{ 0 , 0 , 0 , 0 \} ;$$

$${M}_{y} = {M}_{y} ⪢ 1 = \{ 0 , 1 , 0 , 1 \} ⪢ 1 = \{ 0 , 0 , 1 , 0 \} ;$$

$${C}_{y} = {C}_{y} ⪢ 1 = \{ 0 , 1 , 0 , 0 \} ⪢ 1 = \{ 0 , 0 , 1 , 0 \} ;$$

$${M}_{yy} = - ( {M}_{y} \& 1 ) = - ( \{ 0 , 0 , 1 , 0 \} \& \{ 0 , 0 , 0 , 1 \} ) = - \{ 0 , 0 , 0 , 0 \} = \{ 0 , 0 , 0 , 0 \} ;$$

$${C}_{yy} = - ( {C}_{y} \& 1 ) = - ( \{ 0 , 0 , 1 , 0 \} \& \{ 0 , 0 , 0 , 1 \} ) = - \{ 0 , 0 , 0 , 0 \} = \{ 1 , 1 , 1 , 1 \} ;$$

$$\begin{matrix}{M}_{yy} = {M}_{x} \& {M}_{yy} \vert {M}_{x} \& \sim {C}_{x} \vert {M}_{yy} \& \sim {C}_{yy} \\ = \{ 0 , 0 , 1 , 1 \} \& \{ 0 , 0 , 0 , 0 \} \vert \{ 0 , 0 , 1 , 1 \} \& \sim \{ 0 , 0 , 0 , 0 \} \vert \{ 0 , 0 , 0 , 0 \} \& \sim \{ 0 , 0 , 0 , 0 \} \\ = \{ 0 , 0 , 1 , 1 \} \vert \{ 0 , 0 , 1 , 1 \} \vert \{ 0 , 0 , 0 , 0 \} \\ = \{ 0 , 0 , 1 , 1 \} ;\end{matrix}$$

$${C}_{y} y = {C}_{yy} \& {C}_{x} = \{ 1 , 1 , 1 , 1 \} \& \{ 0 , 0 , 0 , 0 \} = \{ 0 , 0 , 0 , 0 \} ;$$

$$CC = C + {C}_{yy} = \{ 1 , 0 , 0 , 0 \} + \{ 0 , 0 , 0 , 0 \} = \{ 1 , 0 , 0 , 0 \} ; \# the CC is temporary set$$

$$\begin{matrix}M = M \& {M}_{yy} \& \\ ( CC \hat{} \sim ( ( C \vert \sim M ) + ( {C}_{yy} \vert \sim {M}_{yy} ) ) ) \& \\ ( CC \hat{} \sim ( C + ( {C}_{yy} \vert \sim {M}_{yy} ) ) ) \& \\ ( CC \hat{} \sim ( ( C \vert \sim M ) + {C}_{yy} ) ) \\ = \{ 1 , 0 , 0 , 1 \} \& \{ 0 , 0 , 1 , 1 \} \& \\ ( \{ 1 , 0 , 0 , 0 \} \hat{} \sim ( ( \{ 1 , 0 , 0 , 0 \} \vert \sim \{ 1 , 0 , 0 , 1 \} ) + ( \{ 0 , 0 , 0 , 0 \} \vert \sim \{ 0 , 0 , 1 , 1 \} ) ) ) \& \\ ( \{ 1 , 0 , 0 , 0 \} \hat{} \sim ( \{ 1 , 0 , 0 , 0 \} + ( \{ 0 , 0 , 0 , 0 \} \vert \sim \{ 0 , 0 , 1 , 1 \} ) ) ) \& \\ ( \{ 1 , 0 , 0 , 0 \} \hat{} \sim ( \{ 1 , 0 , 0 , 0 \} \vert \sim \{ 1 , 0 , 0 , 1 \} ) + \{ 0 , 0 , 0 , 0 \} ) ) \\ = \{ 0 , 0 , 0 , 1 \} \& \\ ( \{ 1 , 0 , 0 , 0 \} \hat{} \sim ( ( \{ 1 , 0 , 0 , 0 \} \vert \{ 0 , 1 , 1 , 0 \} ) + ( \{ 0 , 0 , 0 , 0 \} \vert \{ 1 , 1 , 0 , 0 \} ) ) ) \& \\ ( \{ 1 , 0 , 0 , 0 \} \hat{} \sim ( \{ 1 , 0 , 0 , 0 \} + ( \{ 0 , 0 , 0 , 0 \} \vert \{ 1 , 1 , 0 , 0 \} ) ) ) \& \\ ( \{ 1 , 0 , 0 , 0 \} \hat{} \sim ( ( \{ 1 , 0 , 0 , 0 \} \vert \{ 0 , 1 , 1 , 0 \} ) + \{ 0 , 0 , 0 , 0 \} ) ) \\ = \{ 0 , 0 , 0 , 1 \} \& \\ ( \{ 1 , 0 , 0 , 0 \} \hat{} \sim ( \{ 1 , 1 , 1 , 0 \} + \{ \{ 1 , 1 , 0 , 0 \} ) ) \& \\ ( \{ 1 , 0 , 0 , 0 \} \hat{} \sim ( \{ 1 , 0 , 0 , 0 \} + \{ 1 , 1 , 0 , 0 \} ) ) \& \\ ( \{ 1 , 0 , 0 , 0 \} \hat{} \sim ( \{ 1 , 1 , 1 , 0 \} + \{ 0 , 0 , 0 , 0 \} ) ) \\ = \{ 0 , 0 , 0 , 1 \} \& \\ ( \{ 1 , 0 , 0 , 0 \} \hat{} \sim \{ 1 , 0 , 1 , 0 \} ) \& \\ ( \{ 1 , 0 , 0 , 0 \} \hat{} \sim \{ 0 , 1 , 0 , 0 \} ) \& \\ ( \{ 1 , 0 , 0 , 0 \} \hat{} \sim \{ 1 , 1 , 1 , 0 \} ) \\ = \{ 0 , 0 , 0 , 1 \} \& \\ ( \{ 1 , 0 , 0 , 0 \} \hat{} \{ 0 , 1 , 0 , 1 \} ) \& \\ ( \{ 1 , 0 , 0 , 0 \} \hat{} \{ 1 , 0 , 1 , 1 \} ) \& \\ ( \{ 1 , 0 , 0 , 0 \} \hat{} \{ 0 , 0 , 0 , 1 \} ) \\ = \{ 0 , 0 , 0 , 1 \} \& \{ 1 , 1 , 0 , 1 \} \& \{ 0 , 0 , 1 , 1 \} \& \{ 1 , 0 , 0 , 1 \} = \{ 0 , 0 , 0 , 1 \} \& \{ 0 , 0 , 0 , 1 \} \\ = \{ 0 , 0 , 0 , 1 \} ;\end{matrix}$$

C=CC & M={1,0,0,0} & {0,0,0,1}={0,0,0,0};

i=i+1=1+1=2;

go to Step 2;

At this point, i=2, and so step 3 is repeated. After four iterations of step 3, one arrives at:

M={0,0,0,1};

C={0,0,0,0}.

So the low-order bit of x*y is known and equal to 0. The remaining bits are not known.

For x*y, the operand non-influence sets are:

Nₓ=0={0,0,0,0};

N_{y}0={0,0,0,0}.

This signifies that each bit in both operands is always relevant in operation mul.

8. Algorithm for SHIFT LEFT LOGIC Operation

FIG. 7 is a schematic diagram depicting the relationship of x, y, Mₓ, M_{y}, Cₓ, C_{y}, M and C for a concrete example of an SHIFT LEFT LOGIC (SLL) operation. Note that the ones in Mₓ and M_{y} correspond to the location of know bit in the associated variable. The technique for calculating M and C from Mₓ, M_{y}, Cₓ, and C_{y} will now be described.

The following psuedo code illustrates calculation of bit sets M, C from similar bit sets Mₓ, Cₓ, M_{y}, C_{y} for operation x<<y:

Step 1:

N_{y}=˜(size of C in bits−1);

M_{y}=M_{y}|N_{y};

C_{y}=C_{y} & ˜N_{y};

M=˜(˜Mₓ<<C_{y});

C=Cₓ<<C_{y};

Nₓ=˜(˜N>>C_{y});

i=1;

If (˜M_{y}==0), go to Quit;

Step 2:

If i>=size of C in bits, go to Quit;

Step 3:

C0=C_{y}|M_{y} & i;

M=M & ˜(˜Mₓ<<C0) & ˜(Cˆ Cₓ<<C0);

i=i+1;

go to Step 2;

Quit:

C=C & M;

For the SLL operation, x<<y, the operand non-influence sets are:

Nₓ=0={0,0,0,0};

N_{y}=0={0,0,0,0}.

This signifies that each bit in both operands is always relevant in operation SLL.

Turning now to FIG. 7, the SLL operation is illutrated for x={0,0, x1, 0}, y={0,0 y1, 1} and N={0,0,0,0}, as on FIG. 8. Then Mₓ={1,1,0,1}, Cₓ{0,0,0,0} and M_{y}={1,1,0,1}, C_{y}={0,0,0,1}. Then the steps of the psuedo code outlined above yield the following:

$$\text{Step 1:}$$

$${N}_{y} = \sim ( 4 - 1 ) = \sim 3 = \sim \{ 0 , 0 , 1 , 1 \} = \{ 1 , 1 , 0 , 0 \}$$

$${M}_{y} = \{ 1 , 1 , 0 , 1 \} \vert \{ 1 , 1 , 0 , 0 \} = \{ 1 , 1 , 0 , 1 \} ; \\ {C}_{y} = \{ 0 , 0 , 0 , 1 \} \& \sim ( 1 , 1 , 0 , 0 ) = \{ 0 , 0 , 0 , 1 \} \& \{ 0 , 0 , 1 , 1 \} = \{ 0 , 0 , 0 , 1 \} ; \\ \begin{matrix}M = \sim ( \sim \{ 1 , 1 , 0 , 1 \} ⪡ \{ 0 , 0 , 0 , 1 \} ) = \sim ( \{ 0 , 0 , 1 , 0 \} ⪡ \{ 0 , 0 , 0 , 1 \} ) = \sim \{ 0 , 1 , 0 , 0 \} \\ = \{ 1 , 0 , 1 , 1 \} ;\end{matrix} \\ C = \{ 0 , 0 , 0 , 0 \} ⪡ \{ 0 , 0 , 0 , 1 \} = \{ 0 , 0 , 0 , 0 \} ; \\ \begin{matrix}{N}_{x} = \sim ( \sim \{ 0 , 0 , 0 , 0 \} ⪢ \{ 0 , 0 , 0 , 1 \} ) = \sim ( \{ 1 , 1 , 1 , 1 \} ⪢ \{ 0 , 0 , 0 , 1 \} ) = \sim \{ 0 , 1 , 1 , 1 \} \\ = \{ 1 , 0 , 0 , 0 \} ;\end{matrix} \\ i = 1 ; \\ if ( \sim \{ 1 , 1 , 0 , 1 \} ⩵ 0 ) , go to Quit ; \\ \text{Step 2:} \\ If 1 > = 4 , go to Quit ; \\ \text{Step 3:} \\ \begin{matrix}{C}_{0} = \{ 0 , 0 , 0 , 1 \} \vert \sim \{ 1 , 1 , 0 , 1 \} \& \{ 0 , 0 , 0 , 1 \} = \{ 0 , 0 , 0 , 1 \} \vert \{ 0 , 0 , 1 , 0 \} \& \{ 0 , 0 , 0 , 1 \} \\ = \{ 0 , 0 , 0 , 1 \} \vert \{ 0 , 0 , 0 , 0 \} = \{ 0 , 0 , 0 , 1 \} ;\end{matrix} \\ \begin{matrix}M = \{ 1 , 0 , 1 , 1 \} \& \sim ( \sim \{ 1 , 1 , 0 , 1 \} ⪡ \{ 0 , 0 , 0 , 1 \} ) \& \sim ( \{ 0 , 0 , 0 , 0 \} \hat{} \{ 0 , 0 , 0 , 0 \} ⪡ \\ \{ 0 , 0 , 0 , 1 \} ) \\ = \{ 1 , 0 , 1 , 1 \} \& \sim \{ 0 , 1 , 0 , 0 \} \& \sim ( \{ 0 , 0 , 0 , 0 \} \hat{} \{ 0 , 0 , 0 , 0 \} ) \\ = \{ 1 , 0 , 1 , 1 \} \& \{ 1 , 0 , 1 , 1 \} \& \sim \{ 0 , 0 , 0 , 0 \} = \{ 1 , 0 , 1 , 1 \} \& \{ 1 , 1 , 1 , 1 \} = \{ 1 , 0 , 1 , 1 \} ;\end{matrix} \\ \begin{matrix}{N}_{x} = \sim ( \sim \{ 1 , 0 , 0 , 0 \} \vert \sim \{ 0 , 0 , 0 , 0 \} ⪢ \{ 0 , 0 , 0 , 1 \} ) = \sim ( \{ 0 , 1 , 1 , 1 \} \vert \{ 1 , 1 , 1 , 1 \} ⪢ \\ \{ 0 , 0 , 0 , 1 \} ) = \sim ( \{ 0 , 1 , 1 , 1 \} \vert \{ 0 , 1 , 1 , 1 \} ) = \sim \{ 0 , 1 , 1 , 1 \} = \{ 1 , 0 , 0 , 0 \} ;\end{matrix} \\ i = i + 1 = 1 + 1 = 2 ; \\ go to Step 2 ; \\ \text{Step 2:} \\ if 2 > = 4 , go to Quit ; \\ \text{Step 3:} \\ \begin{matrix}{C}_{0} = \{ 0 , 0 , 0 , 1 \} \vert \sim \{ 1 , 1 , 0 , 1 \} \& \{ 0 , 0 , 1 , 0 \} = \{ 0 , 0 , 0 , 1 \} \vert \{ 0 , 0 , 1 , 0 \} \& \{ 0 , 0 , 1 , 0 \} \\ = \{ 0 , 0 , 1 , 1 \} ;\end{matrix} \\ \begin{matrix}M = \{ 1 , 0 , 1 , 1 \} \& \sim ( \sim \{ 1 , 1 , 0 , 1 \} ⪡ \{ 0 , 0 , 1 , 1 \} ) \& \sim ( \{ 0 , 0 , 0 , 0 \} \hat{} \{ 0 , 0 , 0 , 0 \} ⪡ \\ \{ 0 , 0 , 1 , 1 \} ) \\ = \{ 1 , 0 , 1 , 1 \} \& \sim ( \{ 0 , 0 , 1 , 0 \} ⪡ \{ 0 , 0 , 1 , 1 \} ) \& \sim ( \{ 0 , 0 , 0 , 0 \} \hat{} \{ 0 , 0 , 0 , 0 \} ) \\ = \{ 1 , 0 , 1 , 1 \} \& \sim \{ 0 , 0 , 0 , 0 \} \& \sim \{ 0 , 0 , 0 , 0 \} \\ = ( 1 , 0 , 1 , 1 \} \& \{ 1 , 1 , 1 , 1 \} \& \{ 1 , 1 , 1 , 1 \} = \{ 1 , 0 , 1 , 1 \} ;\end{matrix} \\ \begin{matrix}{N}_{x} = \sim ( \sim \{ 1 , 0 , 0 , 0 \} \vert \sim \{ 0 , 0 , 0 , 0 \} ⪢ \{ 0 , 0 , 1 , 1 \} ) = \sim ( \{ 0 , 1 , 1 , 1 \} \vert \{ 1 , 1 , 1 , 1 \} ⪢ \\ \{ 0 , 0 , 1 , 1 \} ) = \sim ( \{ 0 , 1 , 1 , 1 \} \vert \{ 0 , 0 , 0 , 1 \} ) = \sim \{ 0 , 1 , 1 , 1 \} = \{ 1 , 0 , 0 , 0 \} ;\end{matrix} \\ i = 2 + 1 = 3 ; \\ go to Step 2 ; \\ \text{Step 2:} \\ If 3 > = 4 , go to Quit ; \\ \text{Step 3:} \\ \begin{matrix}{C}_{0} = \{ 0 , 0 , 0 , 1 \} \vert \sim \{ 1 , 1 , 0 , 1 \} \& \{ 0 , 0 , 1 , 1 \} = \{ 0 , 0 , 0 , 1 \} \vert \{ 0 , 0 , 1 , 0 \} \& \{ 0 , 0 , 1 , 1 \} \\ = \{ 0 , 0 , 1 , 1 \} ;\end{matrix} \\ \begin{matrix}M = \{ 1 , 0 , 1 , 1 \} \& \sim ( \sim \{ 1 , 1 , 0 , 1 \} ⪡ \{ 0 , 0 , 1 , 1 \} ) \& \sim ( \{ 0 , 0 , 0 , 0 \} \hat{} \{ 0 , 0 , 0 , 0 \} ⪡ \\ \{ 0 , 0 , 1 , 1 \} ) \\ = \{ 1 , 0 , 1 , 1 \} \& \sim ( \{ 0 , 0 , 1 , 0 \} ⪡ \{ 0 , 0 , 1 , 1 \} ) \& \sim ( \{ 0 , 0 , 0 , 0 \} \hat{} \{ 0 , 0 , 0 , 0 \} ) \\ = \{ 1 , 0 , 1 , 1 \} \& \sim \{ 0 , 0 , 0 , 0 \} \& \sim \{ 0 , 0 , 0 , 0 \} \\ = \{ 1 , 0 , 1 , 1 \} \& \{ 1 , 1 , 1 , 1 \} \& \{ 1 , 1 , 1 , 1 \} = \{ 1 , 0 , 1 , 1 \} ;\end{matrix} \\ \begin{matrix}{N}_{x} = \sim ( \sim \{ 1 , 0 , 0 , 0 \} \vert \sim \{ 0 , 0 , 0 , 0 \} ⪢ \{ 0 , 0 , 1 , 1 \} ) = \sim ( \{ 0 , 1 , 1 , 1 \} \vert \{ 1 , 1 , 1 , 1 \} ⪢ \\ \{ 0 , 0 , 1 , 1 \} ) = \sim ( \{ 0 , 1 , 1 , 1 \} \vert \{ 0 , 0 , 0 , 1 \} ) = \sim \{ 0 , 1 , 1 , 1 \} = \{ 1 , 0 , 0 , 0 \} ;\end{matrix} \\ i = 3 + 1 = 4 ; \\ go to Step 2 ; \\ \text{Step 2:} \\ If 4 > = 4 , go to Quit ; \\ \text{Quit:} \\ C = \{ 0 , 0 , 0 , 0 \} \& \{ 1 , 0 , 1 , 1 \} = \{ 0 , 0 , 0 , 0 \} ;$$

So the third bit of x−y is unknown. Other bits are known and equal to 0.

For x<<y, the operand non-influence sets are:

Nₓ={1,0,0,0};

N_{y}={1,1,0,0}.

This signifies that high bit of first operand and high two bits of second operand are always unrelevant in the operation SLL.

9. Algorithm for SHIFTRIGHTLOGIC (SRL) Operation

The following algorithm can be used to calculate bit sets M, C from similar bit sets Mₓ, Cₓ, M_{y}, C_{y} for the SRL operation, x>>y:

Step 1:

M_{y}=M_{y}|˜(size of C in bits−1);

C_{y}=C_{y} & (size of C in bits−1);

M=˜(˜Mₓ>>C_{y});

C=Cₓ>>C_{y};

i=1;

If (˜M_{y}==0), go to Quit;

Step 2:

If i>=size of C in bits, go to Quit;

Step 3:

C0=C_{y}|˜M_{y} & i;

M=M & ˜(˜Mₓ>>C0) & ˜(Cˆ Cₓ>>C0);

i=i+1;

go to Step 2;

Quit:

C=C & M.

For x>>y, the operand non-influence sets are:

Nₓ=0={0,0,0,0};

N_{y}=0={0,0,0,0}.

This signifies that each bit in both operands is always relevant in operation srl.

10. Algorithm for SHIFTRIGHTARITHMETIC (SRA) Operation

The following pseudo code illustrates the calculation of bit sets M, C from similar bit sets Mₓ, Cₓ, M_{y}, C_{y} for the arithmetic SRA operation (x>>y):

Step 1:

M_{y}=M_{y}|˜(size of C in bits−1);

C_{y}=C_{y} & (size of C in bits−1);

M=˜(˜Mₓ>>>C_{y});

C=Cₓ>>>C_{y};

i=1;

If (˜M_{y}==0), go to Quit;

Step 2:

If i>=size of C in bits, go to Quit;

Step 3:

C0=C_{y}|˜M_{y} & i;

M=M & ˜(˜Mₓ>>>C0) & ˜(Cˆ Cₓ>>>C0);

i=i+1;

go to Step 2;

Quit:

C=C & M

For x>>y, the operand non-influence sets are:

Nₓ=0={0,0,0,0};

N_{y}=0={0,0,0,0}.

This signifies that each bit in both operands is always relevant in operation sra.

11. Other Operations

Bit sets (M, C) for other operations are calculated analogously.

Use of the Sets

The advantages of the above-described approach are many. The bit sets provided according to these algorithms can be used to simplify common equations such as (x|0xFFFF), so that the time required for the compiler optimization phase is reduced.

The method also allows simplification of complicated expressions. For example, using the sets M and C for an or operation, a compiler can simplify an expression involving the conditional operator, such as:

(x|y)>12?1:0

If, as before x={1, x2, x1, 0} and y={y3, 1, y1, 0}, it follows that, for operation (x|y), M={1,1,0,1} and C={1,1,0,0}. Thus, the value of (x|y) is either 12 or 14. (The value is 12 when the values of x1 and y1 are both 0, and 14 otherwise.) The conditional expression above can then be simplified to examining only the unknown bit of (x|y):

((x|y)>>1)&3

which requires only three very fast operations, i.e., binary or, binary right shift, and binary and. This simplification is made possible using the M, C, and N sets defined above.

In a preferred embodiment of the invention the above-described acts are performed by a CPU executing program code embodied in a computer readable medium. The medium may be magnetic or optical storage media, semiconductor memory, or electromagnetic signals encoding digital data.

The invention has now been described with reference to the preferred embodiments. Alternatives and substitutions will now be apparent to persons of skill in the art. In particular, the particular logical values assigned to the bit sets may be varied. Also, the principles of the invention can be extended to other operations in the manner described above. Accordingly, it is not intended to limit the invention except as provided by the appended claims.

What is claimed is:

1. A method, performed by a compiler executing on a CPU, for constant bit folding an expression having a result determined by binary operations on a plurality of operands in the form of integer bit sets, with each bit set having either a constant or a non-constant in each bit position of the bit set, said method comprising the acts of:
for each operand, forming an operand known-bit set having a first value in bit positions where a corresponding bit position in an associated operand has a constant value and with the known-bit set having a second value in bit positions where a corresponding bit position in the associated operand has a non-constant value;
for each operand, forming an operand value bit set having bit values, in bit positions corresponding to bit positions in the known-bit set equal to the first value, having a constant value equal to the corresponding bit values in the associated operand;
logically processing the operand known-bit sets and operand value bit sets for all operands to form a result known-bit set, having a first value for bit positions corresponding to bit positions in the result having constant values; and
forming a result value bit set having bit values, in bit positions corresponding the bit positions having the first value in said result known-bit set, equal constant values of the result bit set at those values.

2. The method of claim 1 where said step of logical processing further comprises the acts of:
performing selected logical operations, correlated to operations in the expression, on the bits of said operand known-bit sets and operand value bit sets.

3. The method of claim 1 further comprising the steps of:
performing selected logical operations, correlated to operations in the expression, on the operand known-bit sets and operand value bit sets to obtain a non-influence bit set for a first operand having a first value at bit positions of the first operand that have no influence on the values of bit positions of the result.

4. The method of claim 2 where the expression has a result equal to the binary not (˜) operation of a first operand (x), with the operand known-bit set represented by Mₓ and the operand value bit set represented by Cₓ, said method comprising the steps of:
setting the result known-bit set, M, equal to Mₓ; and
setting the result value bit set, C, equal to C=˜Cₓ & M.

5. The method of claim 2 where the expression has a result equal to the binary or (|) operation of a first operand (x) and a second operand (y), with the operand known-bit sets represented by Mₓ and M_{y} and the operand value bit sets represented by Cₓ and C_{y}, said method comprising the steps of:
setting the result value bit set, C, equal to Cₓ|C_{y}; and
setting the result known-bit set, M, equal to Mₓ & M_{y}|C.

6. The method of claim 5 further comprising the step of:
setting the first operand non-influence bit set equal to Nₓ equal to C_{y}|N, and
setting the second operand non-influence bit set, N_{y}, equal to Cₓ|N, where N={0,0,0,0}.

7. The method of claim 2 where the expression has a result equal to the binary and (&) operation of a first operand (x) and a second operand (y), with the operand known-bit sets represented by Mₓ and M_{y} and the operand value bit sets represented by Cₓ and C_{y}, said method comprising the steps of:
setting the result known-bit set, M, equal to Mₓ & M_{y}|Mₓ & ˜Cₓ|M_{y} & ˜C_{y}; and
setting the result value bit set, C, equal to Cₓ & C_{y}.

8. The method of claim 7 further comprising the step of:
setting the first operand non-influence bit set equal to Nₓ equal to ˜(M_{y} & ˜C_{y})|N, and
setting the second operand non-influence bit set, N_{y}, equal to ˜(Mₓ & ˜Cₓ)|N where N={0,0,0,0}.

9. The method of claim 2 where the expression has a result equal to the binary xor (ˆ ) operation of a first operand (x) and a second operand (y), with the operand known-bit sets represented by Mₓ and M_{y} and the operand value bit sets represented by Cₓ and C_{y}, said method comprising the steps of:
setting the result known-bit set, M, equal to Mₓ & M_{y}; and
setting the result value bit set, C, equal to (Cₓˆ C_{y}) & M.

10. The method of claim 2 where the expression has a result equal to the binary addition (+) operation of a first operand (x) and a second operand (y), with the operand known-bit sets represented by Mₓ and M_{y} and the operand value bit sets represented by Cₓ and C_{y}, said method comprising the steps of:
setting the result value bit set, C, equal to Cₓ+C_{y};
setting the result-known bit set, M, equal to Mₓ & M_{y} & (Cˆ ˜((Cₓ|˜Mₓ)+(C_{y}|˜M_{y}))) & (Cˆ ˜(Cₓ+(C_{y}|˜M_{y}))) & (Cˆ ˜((Cₓ|˜Mₓ)+C_{y})); and
resetting the result value bit set, C, equal to C & M.

11. The method of claim 2 where the expression has a result equal to the binary subtraction (−) operation of a first operand (x) and a second operand (y), with operand known-bit sets represented by Mₓ and M_{y} and the operand value bit sets represented by Cₓ and C_{y}, said method comprising the steps of:
setting the result value bit set, C, equal to Cₓ—C_{y};
setting the result known bit set, M, equal to Mₓ & M_{y} & (Cˆ ˜((Cₓ|˜Mₓ)−(C_{y}|˜M_{y}))) & (Cˆ ˜(Cₓ−(C_{y}|˜M_{y}))) & (Cˆ ˜((Cₓ|Mₓ)−C_{y})); and
resetting the result value bit set, C, equal to C & M.

12. The method of claim 2 where the expression has a result equal to the binary multiplication (x) operation of a first operand (x) and a second operand (y), with the operand known-bit sets represented by Mₓ and M_{y} and the operand value bit sets represented by Cₓ and C_{y}, said method comprising the steps of:
setting the result value bit set, M, equal to −(M_{y} & 1);
setting the result value bit set, C, equal to −(C_{y}& 1);
setting the result known bit set, M, equal to M=Mₓ & M|Mₓ & ˜Cₓ|M_{y} & ˜C;
resetting the result value bit set, C, equal to C & Cₓ;
setting an iteration counter, i, equal to 1; and
repeating the following sequence of steps, until the value of the iteration counter, i, equals the size of the result value bit set, C, in bits:
resetting Mₓ=Mₓ<<1;
resetting Mₓ=Mₓ|1;
resetting Cₓ=Cₓ<<1;
resetting M_{y}=M_{y}>>1;
resetting C_{y}=C_{y}>>1;
setting a first internal variable M_{yy}=−(M_{yy} & 1);
setting a second internal variable C_{yy}=−(C_{y} & 1);
setting a first internal variable M_{y}y=Mₓ & M_{y}y|Mₓ & ˜Cₓ|M_{y}y & ˜C_{y}y;
setting C_{y}y=C_{y}y & Cₓ;
setting a third internal variable CC=C+C_{y}y;
setting M=M & M_{y}y & (CCˆ ˜((C|˜M)+(C_{y}y|˜M_{y}y))) & (CCˆ ˜(C+(C_{y}y|˜M_{y}y))) & (CCˆ ˜((C|˜M)+C_{y}y));
setting C=CC & M; and
increasing the value of iteration counter, i, by 1.

13. A computer program product comprising:
a computer readable medium embodying program code therein for, when executed by a processor, causing a computer to constant bit fold an expression having a result determined by binary operations on a plurality of operands in the form of integer bit sets, with each bit set having either a constant or a non-constant in each bit position of the bit set, said program code comprising:
for each operand, program code for forming an operand known-bit set having a first value in bit positions where a corresponding bit position in an associated operand has a constant value and with the known-bit set having a second value in bit positions where a corresponding bit position in the associated operand has a non-constant value;
for each operand, program code for forming an operand value bit set having bit values, in bit positions corresponding to bit positions in the known-bit set equal to the first value, having a constant value equal to the corresponding bit values in the associated operand;
program code for logically processing the operand known-bit sets and operand value bit sets for all operands to form a result known-bit set, having a first value for bit positions corresponding to bit positions in the result having constant values; and
program code for forming a result value bit set having bit values, in bit positions corresponding the bit positions having the first value in said result known-bit set, equal constant values of the result bit set at those values.

14. The computer program product of claim 13 further comprising:
computer program code for performing selected logical operations, correlated to operations in the expression, on the bits of said operand known-bit sets and operand value bit sets.
